(19) United States
(12) Patent Application Publication
(10) Pub. No.: US 2017/0331692 A1
(43) Pub. Date: Nov. 16, 2017

(54) Dsitributing a Network Access Policy

(71) Applicant: Haandle Ltd.

(72) Inventor: Paul Francis Hague, sHEFFIELD (GB)

(21) Appl. No.: 15/534,503

(22) PCT Filed: Dec. 9, 2015
(86) PCT No.: PCT/GB2015/000321

§ 371 Date: Jun. 9, 2017

(30) Foreign Application Priority Data
Dec. 9, 2014 (GB) 1421840.8

(51) Int. Cl. H04L 12/24; H04L 29/06; H04L 12/751; G06F 3/048

(52) U.S. Cl. CPC H04L 41/0893; H04L 63/104; G06F 3/048; H04L 41/12; H04L 63/20; H04L 45/02

(57) ABSTRACT

A system is provided in which a network access policy is distributed from a gateway device to each one of a plurality of user terminals forming a logical device family for enforcement. The gateway device is configured as a router between the Internet and a private local area network. Each one of the plurality of user terminals is capable of connecting to either the private local area network or a cellular data network to access the Internet. The gateway device is configured to distribute the network access policy to each one of the plurality of user terminals, and the network access policy has user-defined parameters specifying terms of access to the Internet. The plurality of user terminals are configured to abide by the network access policy whether they are connected to the private local area network or to the cellular data network.

### CROSS REFERENCE TO RELATED APPLICATIONS

This application represents the first application for a patent directed towards the invention and the subject matter.

### BACKGROUND OF THE INVENTION

### 1. Field of the Invention

The present invention relates to the distribution of a network access policy from a gateway device to each one of a plurality of user terminals forming a logical device family.

### 2. Description of the Related Art

It is known to define policies specifying the terms of access to a network, such as the Internet. These policies often form part of firewall or internet filtering software bundled with operating systems or sourced separately, and are thus invoked only on the terminal on which the software is installed. Other systems are offered by internet service providers for subscribers, and thus apply access policies at the internet connection-level rather than at the device level. These two approaches have been successful for a substantial period of time by preventing inappropriate content from being sourced by, for example, young children.

However, an emerging problem is developing in which particular users have many devices which can connect to a network such as the Internet by more than one method. In addition, different users, possibly in the same household, require different levels of management in terms of what they can and cannot access on the Internet, and how they should be allowed to interact with peers on the network. A smartphone, for example, can interact with the Internet and resources on it via a home internet connection, wireless hotspots, and via a cellular data connection. It can also interact with peers on the subscribed-to GSM (global system for mobile communications) network via voice, SMS (short message service) and MMS (multimedia message service).

Neither the software approach nor the internet service provider approach for the provision of policy enforcement allows for easy management or consistently applied terms of access to these different networks. There is therefore a need for a solution which allows the enforcement of a network access policy for a particular user, which is agnostic as to which of their devices they are using and which mode of network access they are using. There is also a need to enable monitoring and moderation of the interaction of particularly younger users of the Internet and GSM networks within the framework of the network access policy.

### BRIEF SUMMARY OF THE INVENTION

According to an aspect of the present invention, there is provided a system in which a network access policy may be distributed from a gateway device to each one of a plurality of user terminals forming a logical device family for enforcement.

According to another aspect of the present invention, there is provided a method in which a network access policy is distributed from a gateway device to each one of a plurality of user terminals forming a logical device family for enforcement.

### BRIEF DESCRIPTION OF THE DRAWINGS

FIG. 1 shows an exemplary technical environment in which the present invention may be deployed;

FIG. 2 shows network access policy 109;

FIG. 3 shows a high-level flow of procedures carried out in the system according to the present invention;

FIG. 4 shows the hardware components making up local gateway 105;

FIG. 5 shows instructions and data held in memory in the local gateway 105 for execution by processor 404;

FIG. 6 shows the hardware forming remote enforcement server 110;

FIG. 7 shows a mapping of instructions held in memory by the remote enforcement server 110 and run thereon;

FIG. 8 shows the hardware forming first smartphone 102;

FIG. 9 shows USIM 806;

FIG. 10 shows a mapping of instructions in memory and being run by smartphone 102;

FIG. 11 shows a mapping of instructions in memory and run by smartphone 103;

FIG. 12 shows an exemplary graphical user interface made available by the local gateway 105;

FIG. 13 shows an overview of procedures invoked by when adding a new device and its registration with local gateway 105;

FIG. 14 shows an exemplary set of graphical user interfaces presented to a user during configuration and registration of a new device with local gateway 105;

FIG. 15 shows procedures undertaken by local gateway 105 following step 1307;

FIG. 16 shows procedures carried out by the distribution service 508 to update a network access policy;

FIG. 17 shows steps carried out during step 1605 to distribute a policy to all applicable devices;

FIG. 18 shows the relationship between devices, users, policies and logs;

FIG. 19 shows a high level overview of procedures undertaken to enforce a network access policy against TCP/IP data;

FIG. 20 shows steps carried out to determine whether a content being received via the Internet complies with a policy;

FIG. 21 shows steps carried out to process packet contents so as to perform content based filtering;

FIG. 22 shows step 2002 in greater detail;

FIG. 23 shows example warning dialog boxes which can be displayed on a user terminal;

FIG. 24 shows Procedures carried out by the baseband service 1003 when a GSM access request is received;

FIG. 25 shows procedures carried out to assess a GSM access request's compliance with a policy; and

FIG. 26 shows step 2503 in greater detail.

### DETAILED DESCRIPTION OF EXAMPLE EMBODIMENTS

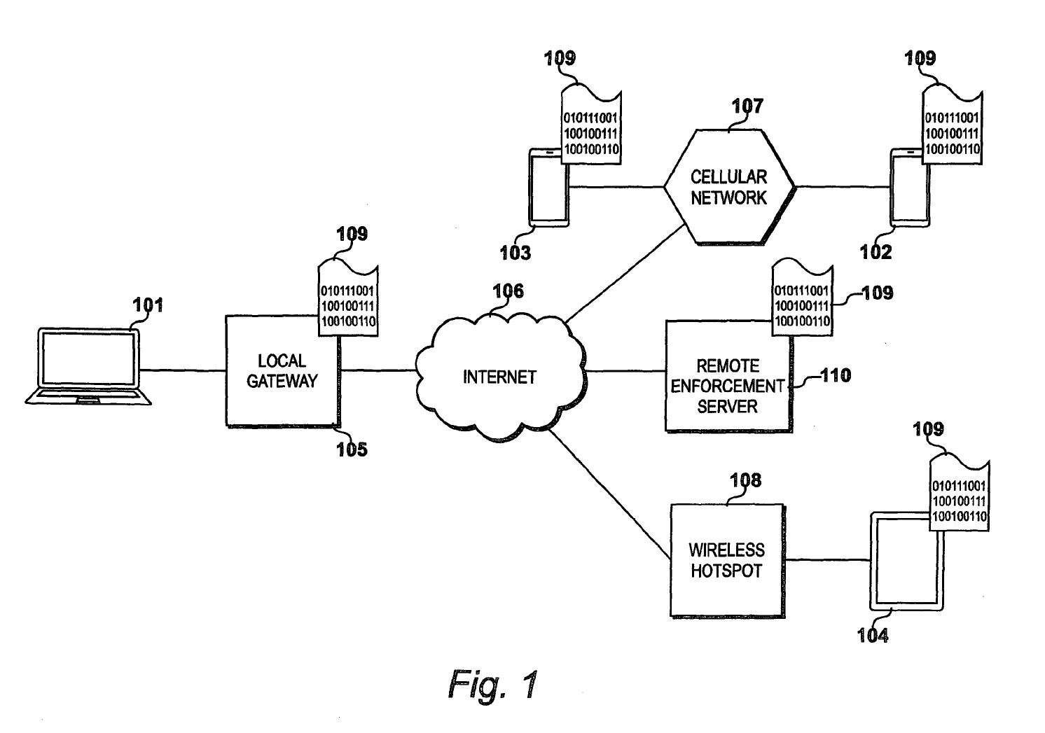

### FIG. 1

An exemplary technical environment in which the present invention may be deployed is illustrated in FIG. 1, in which a number of user terminals are shown and form a logical device family.

The device family comprises in the example a first user terminal in the form of a personal computer 101 (in this example a notebook), a second user terminal in the form of a first smartphone 102, a third user terminal in the form of a second smartphone 103, and a fourth user terminal in the form of a tablet computer 104.

In the present example, the notebook computer 101 is connected to a residential local area network provided with internet access by a local gateway 105. The local gateway 105 provides routing and modem functionality of the known type between the local area network and the Internet. In this way, it acts as a router and provides notebook computer 101, and any other connected device, with access to the Internet 106.

As shown in the Figure, the first smartphone 102 and the second smartphone 103 are connected to a cellular network 107 to provide telecommunication services such as voice, short message service etc. in accordance with GSM. The cellular network 107 also provides access to the Internet 106 by providing data services, possibly using HSPA (high-speed packet access) or LTE (long-term evolution) connections to the first smartphone 102 and the second smartphone 103.

The tablet computer 104 is in the present example connected via a wireless network connection (e.g. WiFi®) to a wireless hotspot 108 which provides Internet access.

In addition to typical residential gateway functionality, the local gateway 105, in accordance with the present invention, manages the configuration, distribution and local enforcement of a network access policy 109 to each device in the logical device family.

Policy enforcement for Internet traffic outwith the residential network established by the local gateway 105 is handled either on-device or by way of a remote enforcement server 110, which may be connected to via the Internet 106. This in the present embodiment is achieved by setting appropriate proxy server settings on the user terminal, or alternatively could be achieved by establishing the remote enforcement server 110 as a transparent proxy by setting the DNS (domain name system) server settings of the client device to point to the remote enforcement server 110.

In the present example, the smartphone 102 and tablet computer 104 run what will be termed herein an “open” mobile operating system, i.e. one which allows the installation and running of background services that have access to data and telephone interfaces. Examples of such operating systems include Google® Android® and Microsoft® Windows Phone®.

The smartphone 103 on the other hand is one which runs what will be termed herein a “closed” mobile operating system, i.e. one which does not allow the installation and running of background services that have access to data and telephone interfaces. Examples of such operating systems include Apple® iOS®.

The present invention provides technical solutions to ensure that policy enforcement is consistent regardless of the operating system type, and the type of network being used. In this way, each of the user terminals abides by its installed network access policy irrespective of the network it is connected to.

It will be appreciated by those skilled in the art that the gateway 105 is in practice capable of managing a number of network access policies for a large number of devices, so as to support different network access policies for different users.

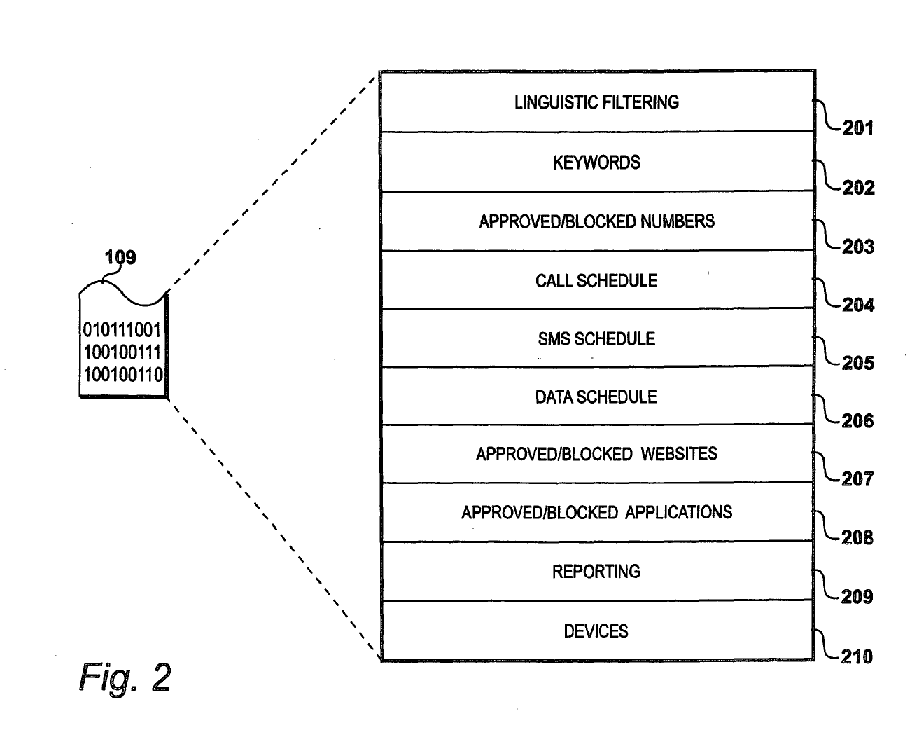

### FIG. 2

Network access policy 109 is illustrated in FIG. 2. In the present embodiment, the network access policy is a bit array which encodes various user-defined parameters detailing particular restrictions on network access. In the present embodiment, the network access policy is encrypted, possibly using public key encryption.

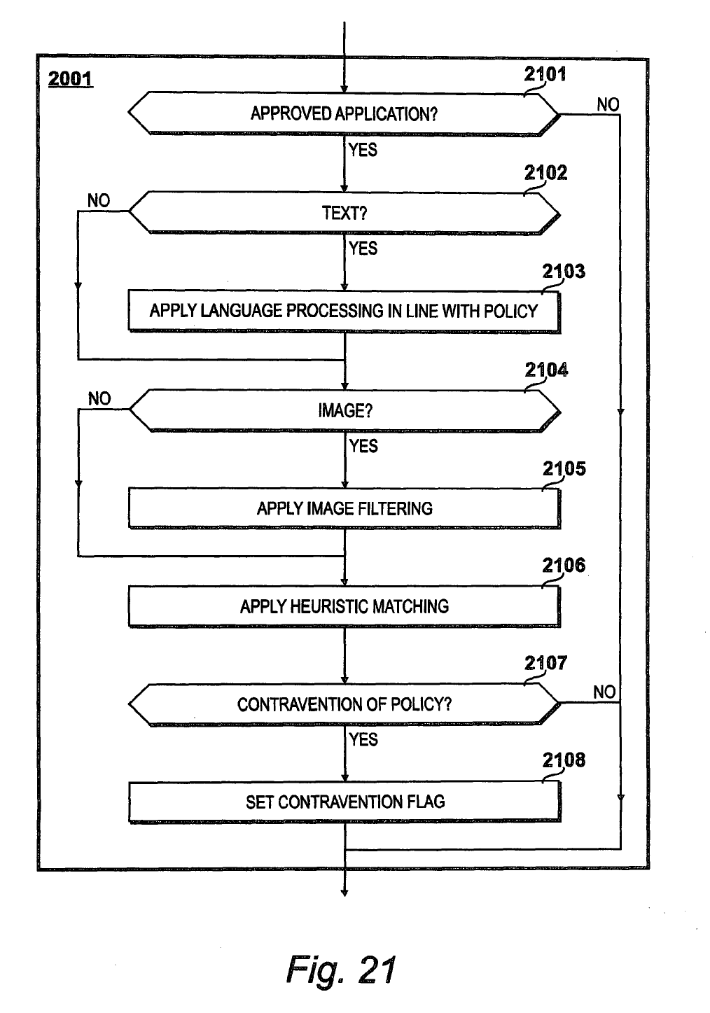

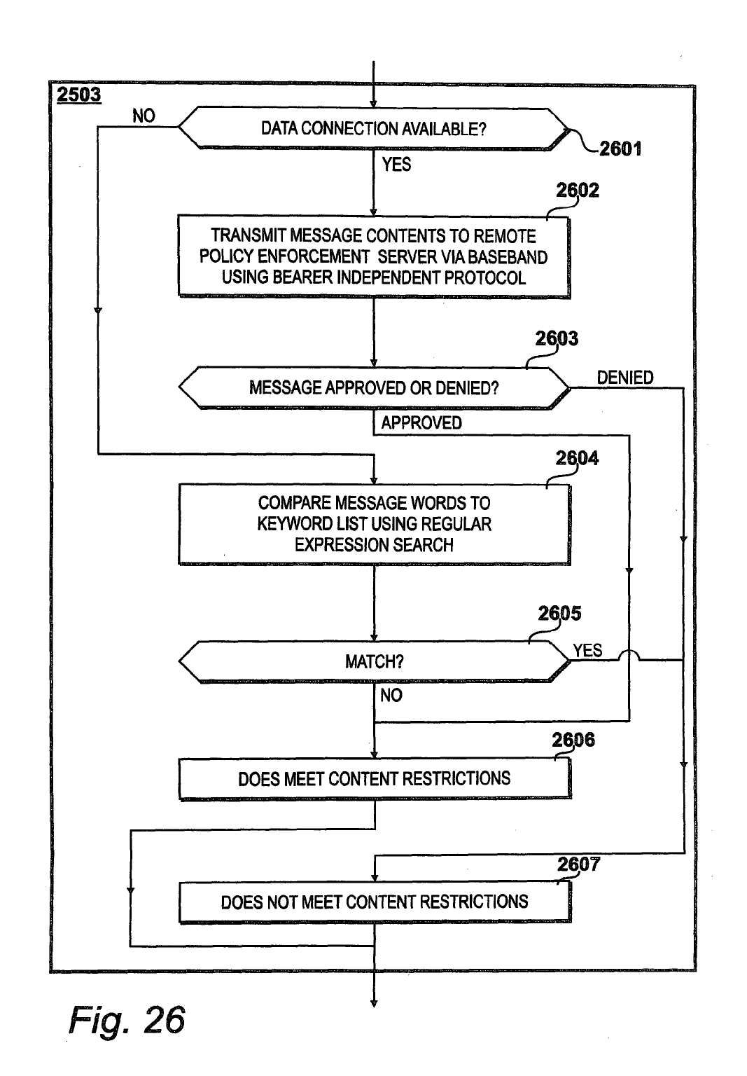

The current embodiment of the present invention provides support for specifying acceptable use of the Internet. This is achieved by performing linguistic filtering of messages and content being sent from and received at user terminals, and so the network access policy 109 includes a first corresponding field 201 to, in one embodiment, either indicate that filtering should be on or off (binary data). Alternatively, different degrees of linguistic filtering could be selected, possibly prohibiting foul language, or alternatively particular sentiments, along with prohibiting access to particular kinds of content. As will be described further with reference to FIG. 21 and FIG. 26, sophisticated natural language processing techniques can be invoked to probe messages and determine whether they are appropriate or not, as well as processing of images to identify if their content is acceptable or not in the context of the network access policy.

Support for keyword identification is provided, with a second corresponding field 202 allowing the storage of unwanted keywords.

Either a whitelist or a blacklist of telephone numbers can be stored in a third corresponding field 203, preventing calls and messages being sent to and received from a GSM-enabled device.

A schedule defining allowed periods in which calls can be made and received is stored in a fourth corresponding field 204, and a schedule defining allowed periods in which SMS messages can be sent and received is stored in a fifth corresponding field 205. A data schedule is defined in a sixth corresponding field 206.

Further acceptable usage can be defined, with provision for either a whitelist or a blacklist of websites which may be stored at a seventh corresponding field 207, along with a whitelist or a blacklist of applications which may be stored at an eighth corresponding field 208. Levels of reporting can be defined in a ninth corresponding field 209, allowing simple logging of the fact that policy contraventions have occurred to full storage of the content contravening the policy for example. Finally, devices to which the policy is applicable are stored in a tenth corresponding field 210. Unique identifiers, possibly a hash of the MAC (media access control) address of each device, are used.

It will be appreciated by those skilled in the art that the exact terms specified in the network access policy 109 can be added to and reduced in accordance with the implementation, and rather the present invention is directed to the policy's consistent application across devices and networks, irrespective of what the policy specifies.

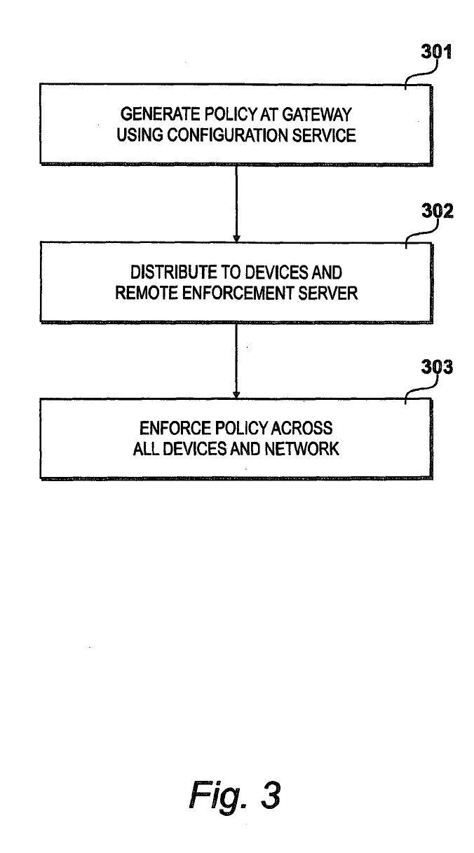

### FIG. 3

A high-level flow of procedures carried out in the system according to the present invention is set out in FIG. 3.

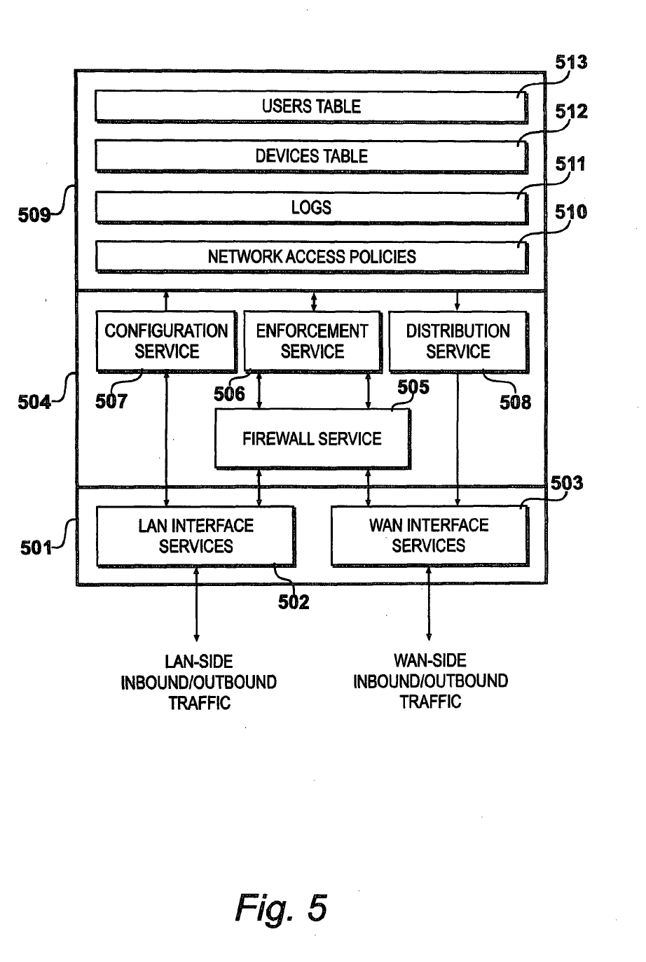

At step 301, a network access policy is generated at the local gateway 105, using a configuration service provided thereon (508, FIG. 5). At step 302, the network access policy is distributed to each target user terminal 101 to 104, along with the remote enforcement server 110. Following distribution of the network access policy, it is enforced on all target user terminal 101 to 104, on every network it connects to. In this way, the user terminals abide by the network access policy whether they are connected to the residential local area network, or to a cellular data network, or even to for example a wireless hotspot.

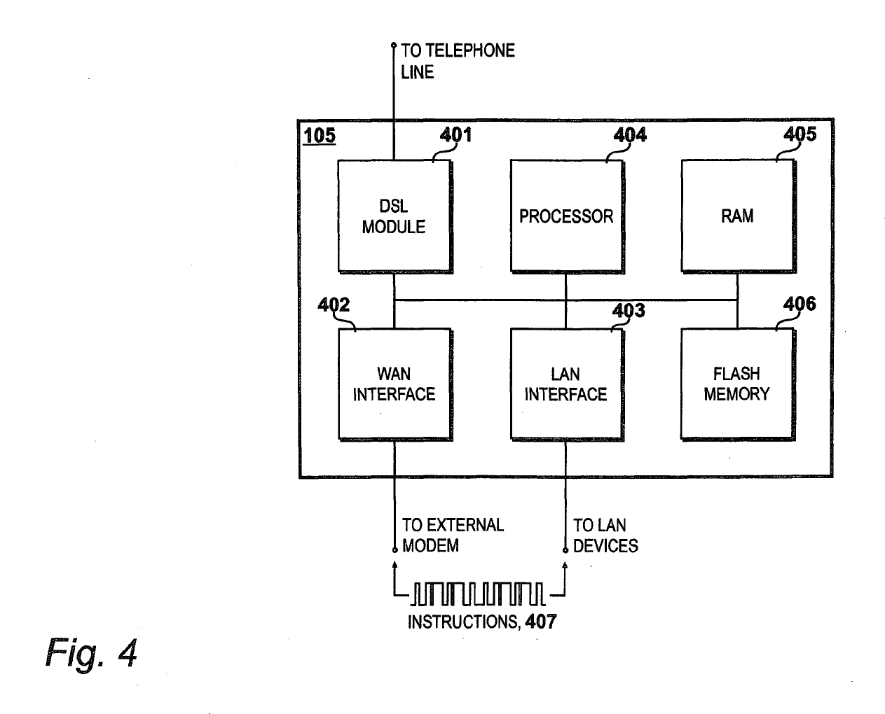

FIG. 4

As described previously with reference to FIG. 1, local gateway 105 provides routing functionality between the Internet 106 and a residential local area network. The hardware components making up local gateway 105 are shown in FIG. 4.

Connectivity to the Internet 106 is provided by either a DSL (digital subscriber line) module 401 which may be connected to a telephone line, or a WAN (wide area network) interface 402 which may be connected to an external cable modem for example. Both of DSL module 401 and WAN interface 402 are of the known type and their operation will be familiar to those skilled in the art.

Connection to a residential local area network is provided by a LAN (local area network) interface 403 providing Ethernet connectivity, and which may be connected to other LAN devices, such as a WLAN (wireless LAN) interface providing IEEE 802.11-type connectivity for user terminals.

A processor 404 executes instructions to facilitate routing of network traffic between the local area network and the Internet 106. In addition, the processor 404 executes instructions that facilitate policy configuration, distribution and enforcement. These instructions along with additional state information are stored in RAM (random access memory) 405, following loading from non-volatile Flash memory 406. A mapping of instructions within the memory of local gateway 105 is shown in FIG. 5. These instructions, illustrated as 407, may be loaded into the Flash memory in the local gateway 105 by way of a data upload, either from a remote server on the Internet 106, or a local device on the LAN.

In an alternative embodiment, the processor 404, RAM 405 and Flash memory 406 may be provided on a discrete add-in card for standard residential gateways, supplementing their existing processing capability.

### FIG. 5

Instructions and state held in memory in the local gateway 105 for execution by processor 404 are mapped out in FIG. 5.

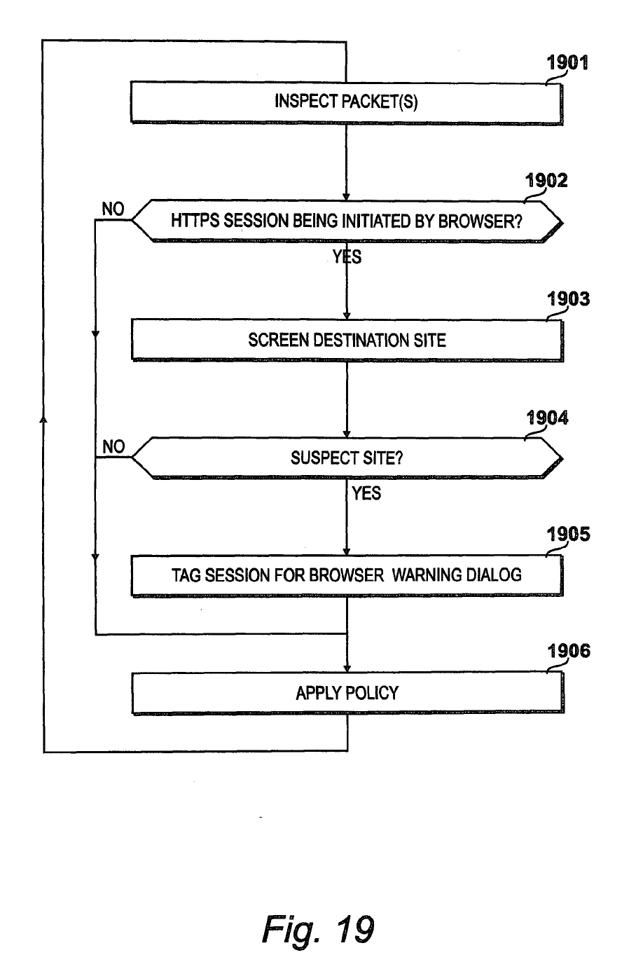

At a lower layer 501, LAN interface services 502 are stored and run for managing local area network tasks, and include typical services such as DHCP (dynamic host configuration protocol) etc. Wan interface services 503 are stored and run for managing wide area network tasks, such as network address translation etc. At a middle layer 504, a firewall service 505 manages the flow of traffic between the LAN and WAN sides of the local gateway 105. Procedures carried out by the firewall service 505 will be described with reference to FIG. 19.

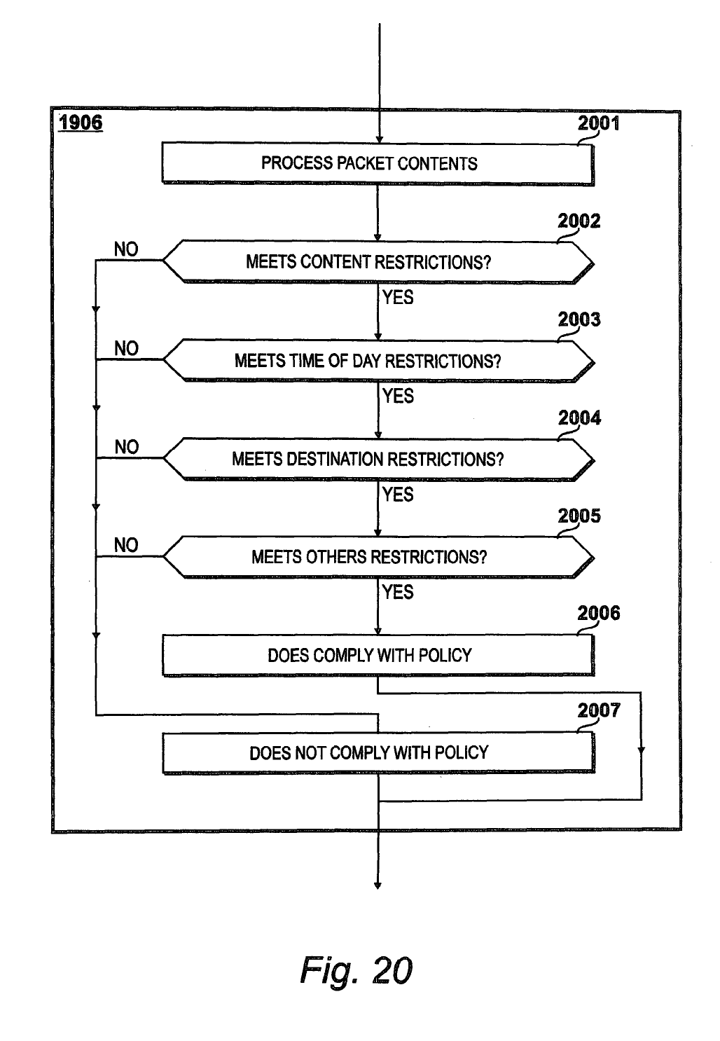

The firewall service 505 operates in conjunction with an enforcement service 506, referring traffic to it to assess its compliance with the appropriate network access policy. Procedures carried out by enforcement service 506 will be described with reference to FIGS. 20 to 22.

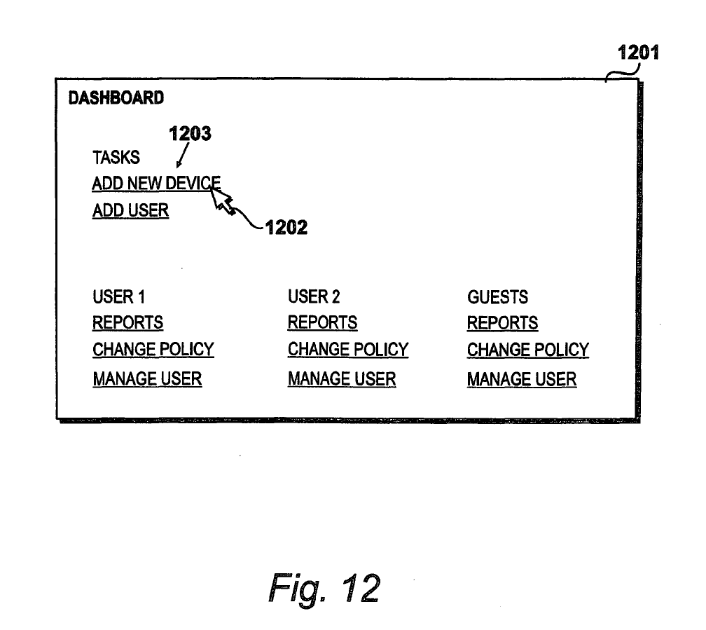

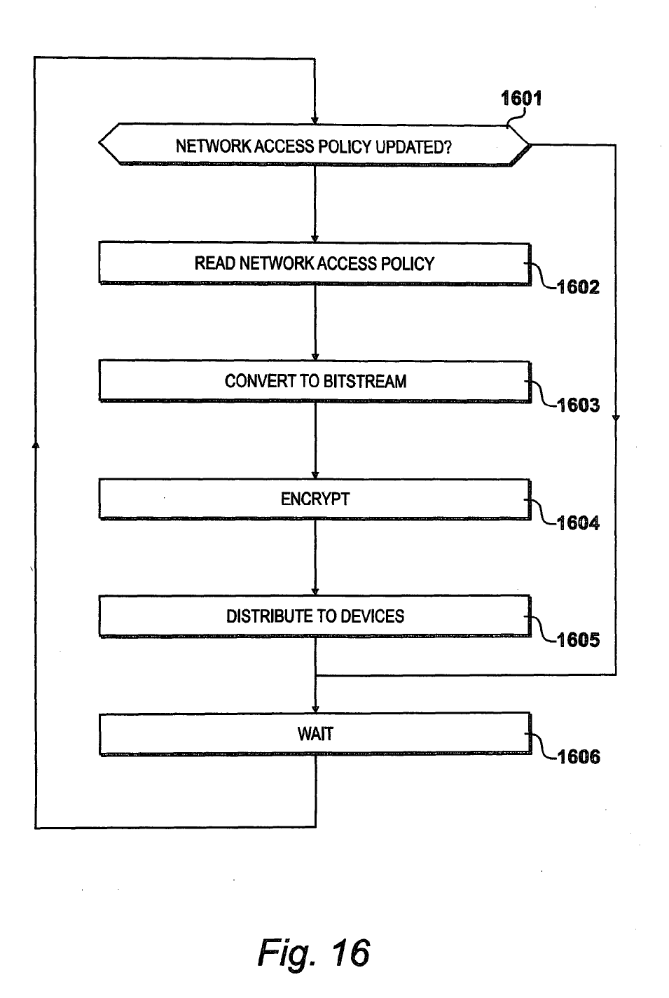

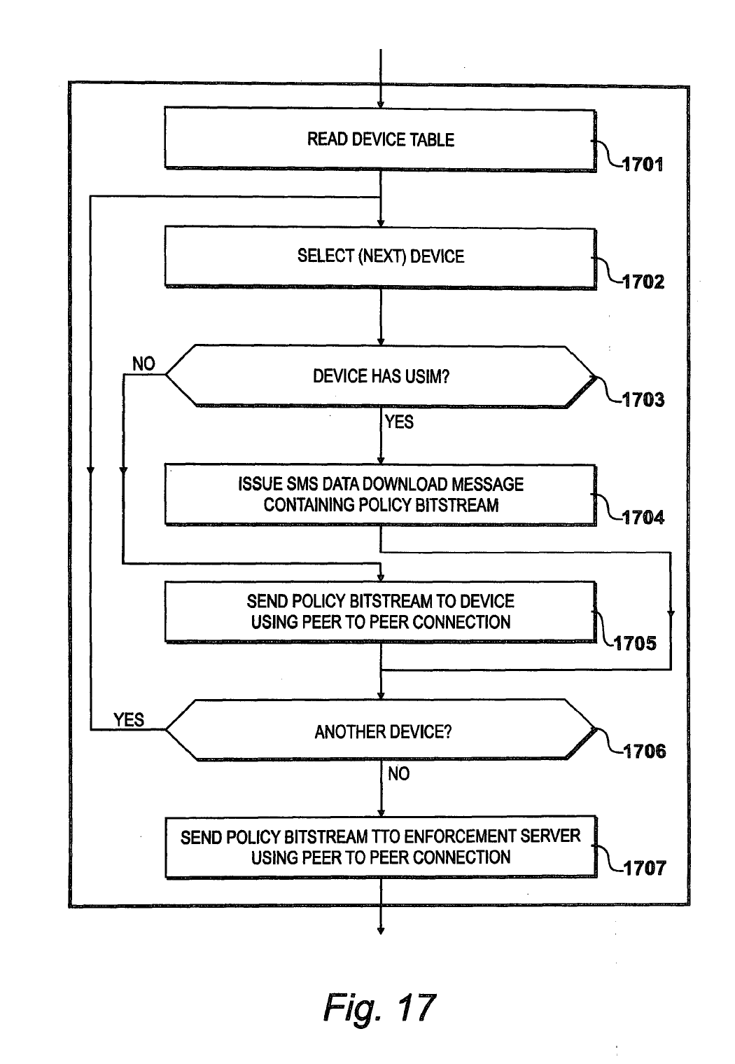

Operating alongside enforcement service 506 is a configuration service 507, and a distribution service 508. Configuration service 507 allows the creation and application of policies to particular devices and users, and distribution service 508 is responsive to such changes so that network access policies stored on devices can be updated appropriately. Procedures carried out by configuration service 507 will be described with reference to FIGS. 12 to 15, and procedures carried out by the distribution service 508 will be described further with reference to FIGS. 16 and 17.

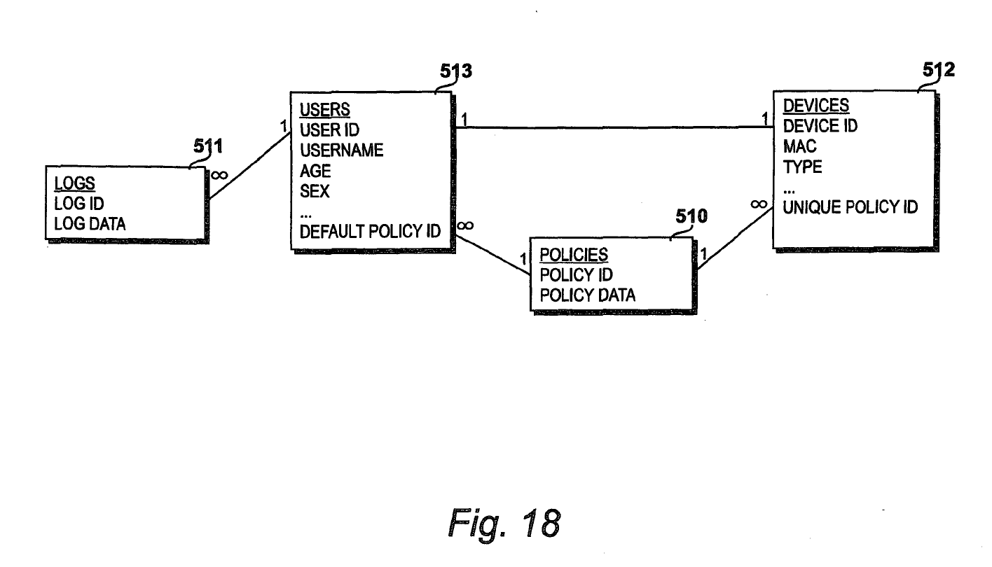

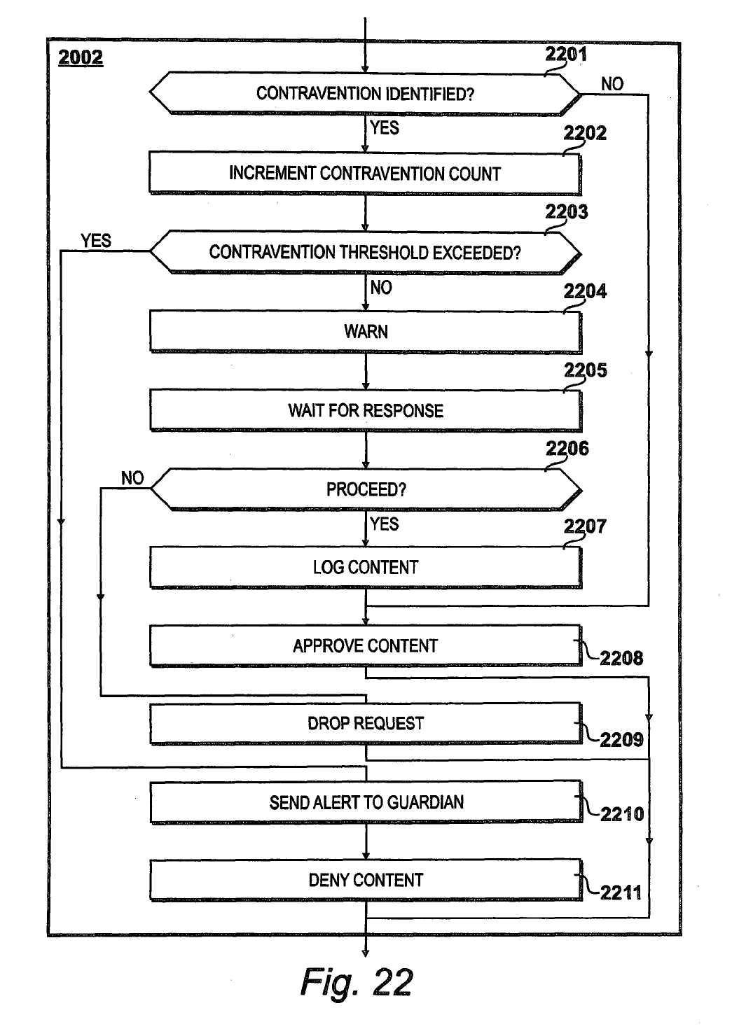

State and data is stored at a top layer 509, for reference by the various services. Network access policies 510, including network access policy 109, are written to by configuration service 507, and read by enforcement service 506 and distribution service 508. Logs are written directly to by enforcement service 506, as will be described with reference to FIG. 22. A devices table 512 stores the required detail about each user terminal, such as MAC address, device type, etc. along with its users and currently installed network access policy. Details of registered users are stored in a users table 513, which contains data pertaining to their name, age, sex, assigned devices and which of the access policies 510 they must abide by, etc. The relationship between the access policies, logs, devices table and users table is described with reference to FIG. 18.

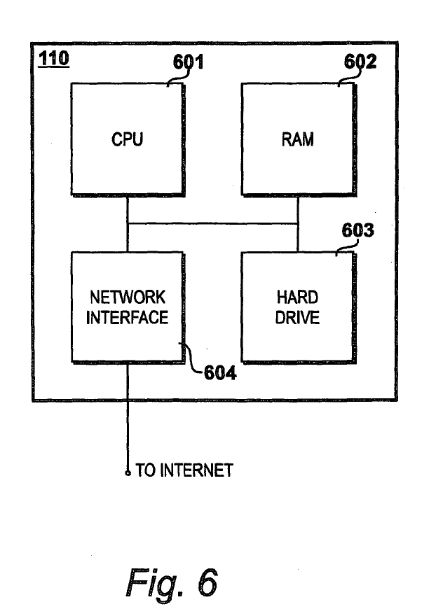

### FIG. 6

As previously described with reference to FIG. 1, remote enforcement server 110 provides policy enforcement when user terminals are not connected to the Internet 106 via local gateway 105. This is achieved in the present implementation by adjusting either the proxy server settings or the DNS settings of the user terminal such that Internet traffic routes via the remote enforcement server 110. In practice, this means that irrespective of whether the user terminal is connected to the Internet for example via cellular network 107 or via wireless hotspot 108, data traffic can be inspected for policy compliance.

The hardware forming remote enforcement server 110 is shown in FIG. 6, and is of the conventional type including a processor provided by a CPU (central processing unit) 601, memory provided by RAM 602, permanent storage in the form of a hard drive 603 and a network interface 604. It will be appreciated that in an embodiment, remote enforcement server 110 could be a virtual machine hosted by a hypervisor running on a physical device in the known manner.

In practice, instructions for the remote enforcement server 110 are stored on hard drive 603, loaded into RAM 602 and run by CPU 601.

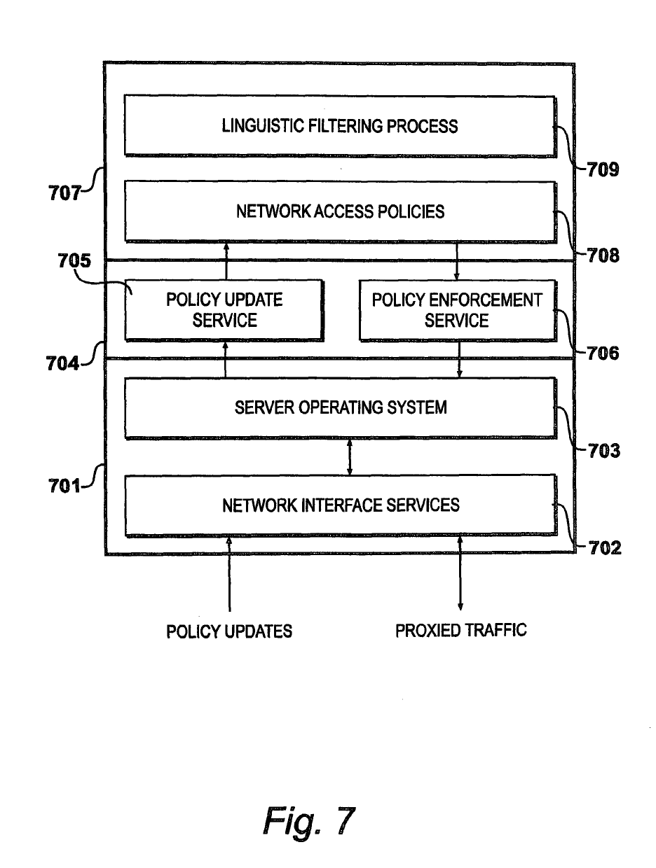

### FIG. 7

A mapping of instructions and state held in memory by the remote enforcement server 110 and run thereon is shown in FIG. 7.

At a lower level 701, network interface services 702 are provided which in conjunction with the server operating system 702—in this embodiment a GNU/Linux® distribution—allow the receipt and re-transmission of proxied traffic from user terminals subject to network access policies. At a middle level 704, a policy update service 705 responds to policy updates issued by distribution service 508 over the Internet 106. A policy enforcement service 706 is also provided to carry out processing of traffic in accordance with the corresponding network access policy. Procedures undertaken by the policy enforcement service 706 in relation to a particular network access policy for a particular device are the same as those carried out by the enforcement service 506 which runs on local gateway 105.

A higher level 707 contains access policies 708, including, in the present exemplary environment, network access policy 109. In one embodiment, all policies applicable to each device for every gateway in are stored by the remote enforcement server 110. Policy enforcement service 706 processes network traffic by identifying the source of the network traffic and comparing it to the corresponding policy, possibly using a hash of the MAC address of the device from which the traffic originated. Such methods will be apparent to those skilled in the art.

Finally, a sophisticated linguisiting filtering process 709 is provided to provide support for natural language processing and sentiment analysis on messages either proxied through the remote enforcement server 110, or dispatched to it by smartphones 102 and 103, for example, as will be described with reference to FIG. 26.

In an alternative embodiment, the remote enforcement server 110 is specific to only the local gateway 105, and so only stores the policies which are also stored on the gateway device. In a further possible embodiment, the remote enforcement server 110 exists for only one device, and, in this case, is virtualised so as to allow it to be spawned on an on-demand basis when the corresponding device is not connected to the Internet 106 via local gateway 105.

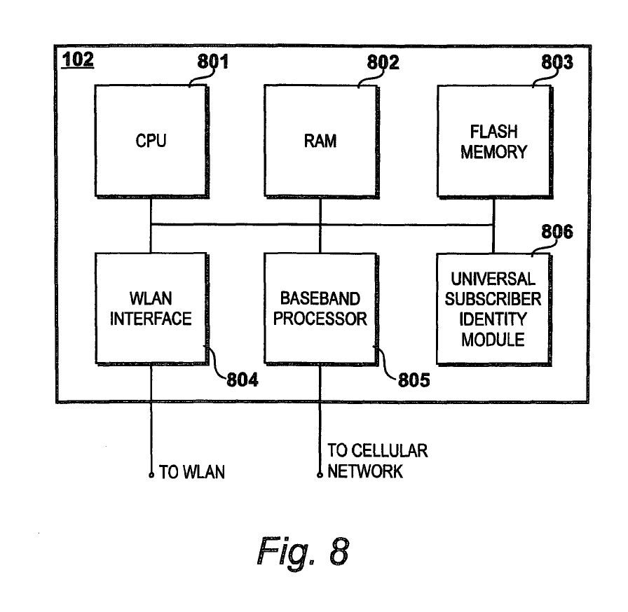

### FIG. 8

In practice, development and installation of services for policy enforcement on personal computers, such as notebook computer 101, is a routine task, as is the configuration of proxy and DNS server settings.

However, it is not always possible to enforce policies in this way on GSM communications (voice and SMS), particularly in closed mobile operating systems. Thus the present invention adopts a technical approach to providing an on-device solution to enforcing a network access policy to voice and SMS communications over a cellular network.

The hardware forming first smartphone 102 is shown in FIG. 8, with the hardware for second smartphone 103 being identical. The first smartphone 102 has processing capability provided by a CPU 801, typically an ARM® processor, and memory provided by a combination of RAM 802 and non-volatile Flash memory 803. A WLAN interface 804 is provided and is configured to allow first smartphone 102 to connect to wireless local area networks such as those of the IEEE 802.11-type. In addition, connection to cellular networks such as cellular network 107 is facilitated by a baseband processor 805 in combination with a USIM (universal subscriber identity module) 806. It will be appreciated that each hardware component identified in FIG. 8 is of the known type, and that the approach adopted by the present invention is agnostic as to the particular hardware layout of the mobile device, taking advantage of the fact that all smartphones must be compliant with mobile telecommunications standards.

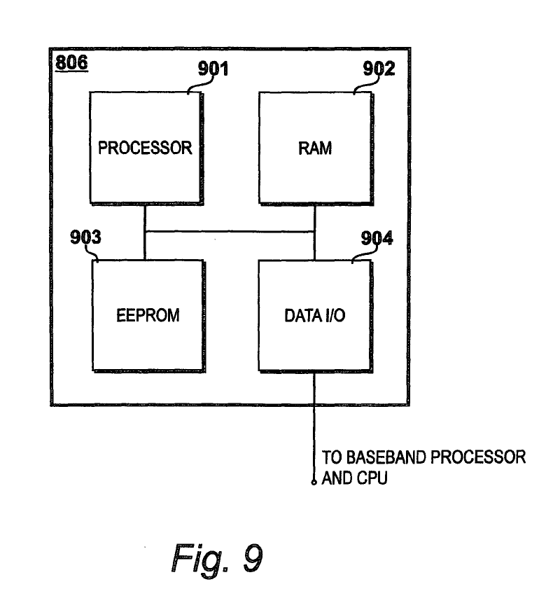

### FIG. 9

USIM 806 is shown in greater detail in FIG. 9. As will be familiar to those skilled in the art, a subscriber identity module conforms to the Smart Card standard, and as such includes a degree of in-built computing capability to support identity services etc. Thus, the USIM 806 includes its own processor 901, RAM 902, permanent storage in the form of EEPROM 903 and a data interface 904 for interfacing with the host—in this case the CPU 801 and baseband processor 805 of smart phone 102. The provision of processing capability allows the USIM to run processes and applications when it is in use by the smartphone 102. Built on the Java Card Platform, the applications (either applets or servlets) communicate with the smartphone 102 using the USIM application toolkit.

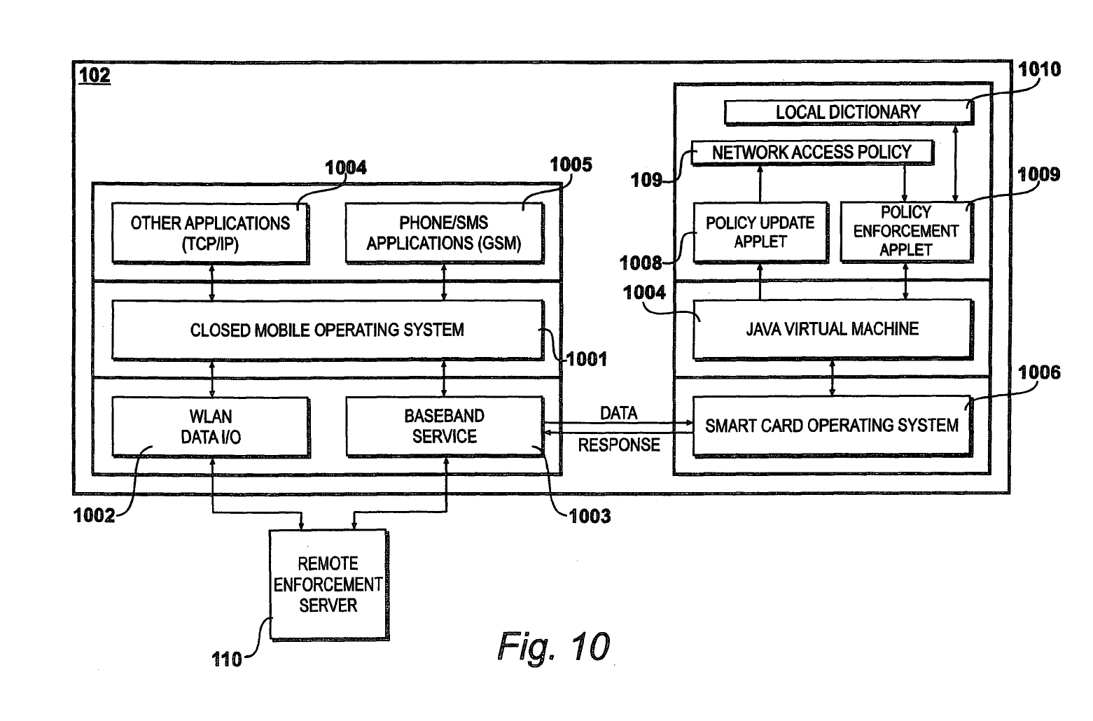

### FIG. 10

A mapping of instructions in memory and being run by smartphone 102 is shown in FIG. 10. It will be recalled that smartphone 102 runs what has been termed herein a closed mobile operating system 1001. The implication of this is that background services that listen for and act upon certain events in the required way in order to enforce a network access policy cannot always be installed. The present invention therefore adopts for such operating system types a technical approach to providing the required functionality within the constraints of the programming environment.

The closed mobile operating system 1001 is capable of providing data connectivity utilising TCP/IP via both a WLAN data. I/O service 1002 presented by the WLAN interface 804 for data connectivity over a wireless LAN, and via a baseband service 1003 presented by the baseband processor 805 for data connectivity over cellular network 107. The specific mode of TCP/IP data connectivity is abstracted by the closed mobile operating system 1001 which simply allows applications 1004 to send and receive data, with the exact channel over which data is sent and received being managed by the operating system. The present invention solves the problem of enforcement of network access policies upon data connections by specifying, in the present embodiment, the remote enforcement server 110 as both a proxy server for the WLAN data I/O service 1002, and a proxy server for baseband service 1003 in its APN (access point name) settings.

In order to enforce the network access policy for telephone and short message service applications 1005 which utilise the GSM functionality of the baseband processor 804, the present invention adopts a different approach.

This is because it is not possible solely within the confines of the closed mobile operating system 1001 to provide a mechanism by which calls and SMS messages can be vetted against a network access policy.

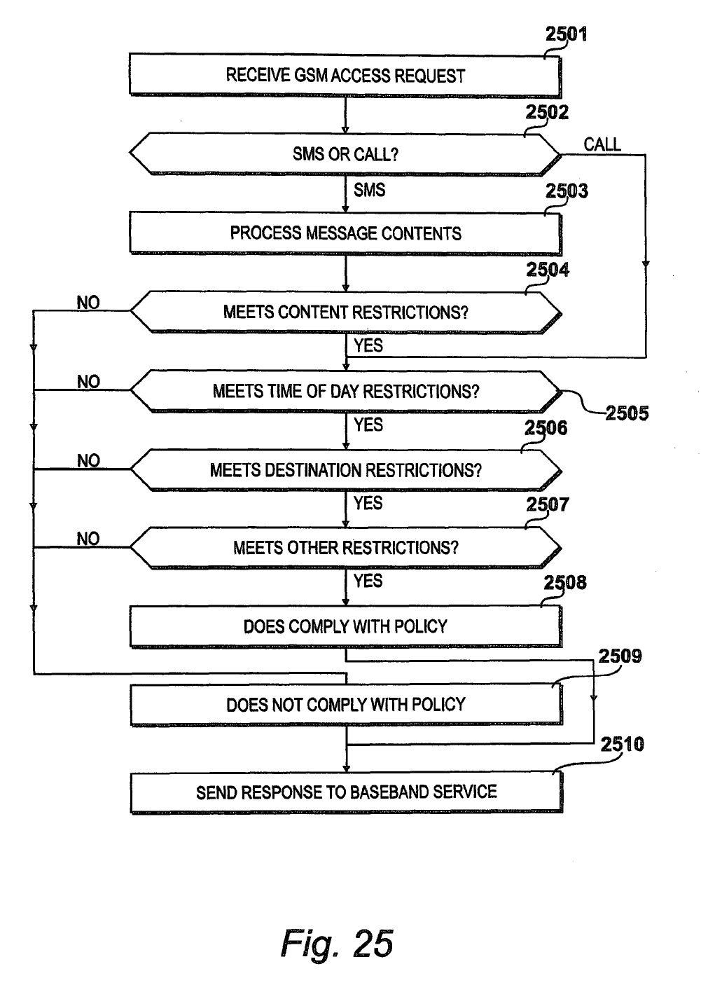

As described previously with reference to FIG. 9, the USIM 806 includes a degree of in-built computing capability, managed by a smart card operating system 1006. Java bytecode is executed by a Java virtual machine 1007 running on top of the smart card operating system 1006—the arrangement of which is standard for smart cards. In combination, the smart card operating system 1006 and the Java virtual machine 1007 provide USIM application toolkit functionality. In the present embodiment two applets are provided for facilitating the application of network access policies: a policy update applet 1008, and a policy enforcement applet 1009. Both of the applets have access to and may respectively write to (for updating purposes) and read from the network access policy 109. In the present embodiment, a local dictionary 1010 is also provided for local linguistic filtering and keyword matching for SMS messages—the application of which will be described with reference to FIG. 25.

In the present example, the policy update applet 1008 is registered with the USIM application toolkit for receiving data when SIM data download-type SMS messages are received. In this way, network access policies can be silently received at the USIM 806, whereupon the policy update applet 1008 may update the access policy 109. This process will be described further with reference to FIGS. 16 and 17.

The policy enforcement applet 1009 is also registered with the USIM application toolkit, but for Call Control and SMS Control events. These events are raised when the baseband service 1003 either asks permission from the USIM 806 to begin a call or send an SMS, or connect an incoming call or receive an SMS. In this way, GSM network access is managed by the policy enforcement applet 1009 against the policy.

In an alternative embodiment, the proxy server settings for the baseband service 1003 could be set to point to a Java servlet provided within the USIM 806 alongside the policy update and enforcement applets. Policy enforcement for HTTP requests for particular websites and from particular applications could then take place locally on the smartphone 102, or the servlet could be configured to direct requests to an external service such as the remote enforcement server 110 using bearer independent protocol to transmit packet data via the baseband service 1003.

It will therefore be seen that the present invention provides a mechanism by which policy enforcement can be achieved on smartphone 102, in terms of both controlling network access irrespective of the particular network and network type.

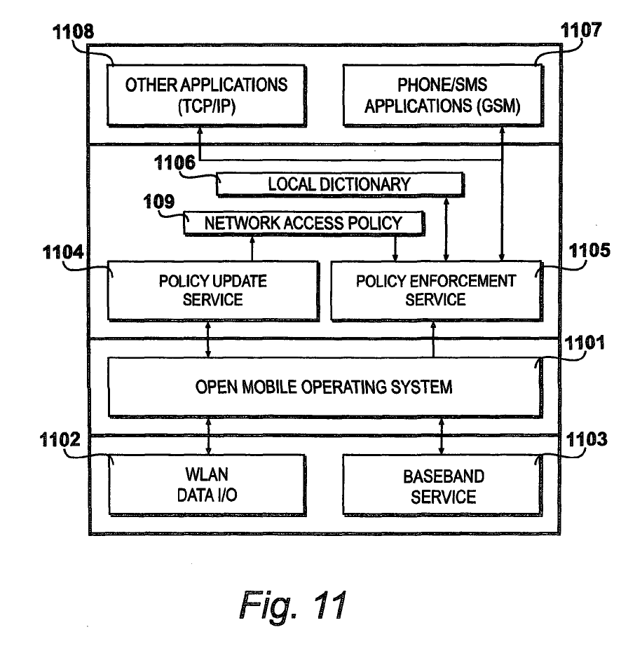

### FIG. 11

As described previously, smartphone 103, whilst having substantially identical hardware to smartphone 102, runs what is termed herein an “open” mobile operating system and as such allows the installation of background services which can handle and control events such as data requests over wireless networks and cellular networks, along with control over GSM functionality in accordance with the network access policy 109.

A mapping of instructions in memory which are run by smartphone 103 is therefore illustrated in FIG. 11. Running an open mobile operating system 1101, smartphone 103 is capable of providing data connectivity utilising TCP/IP via both a WLAN data I/O service 1102 and via a baseband service 1003 for data connectivity over cellular network 107. A policy update service 1104 and a policy enforcement service 1105 provide substantially the same functionality as policy update service 1004 and policy enforcement service 1005, but instead run on the CPU of smartphone 103 rather on its USIM. Policy update service 1104 and policy enforcement service 1105 again maintain and refer to a copy of the access policy 109. This allows the policy enforcement service 1105, possibly with reference to a local dictionary 1106, to enforce the access policy 109 against both GSM calls and SMS messages from phone and SMS applications 1107, and against TCP/IP traffic from other applications 1108.

It will be appreciated that the present invention therefore provides a full suite of functionality so as to enable the enforcement of policies regardless of operating system type and regardless of network type. Indeed, the USIM applets described herein could be installed in combination with the services described herein if necessary, depending on the technical constraints of the device and its operating system.

### Policy Configuration and Distribution

### FIG. 12

An exemplary graphical user interface made available by the local gateway 105, possibly through a web browser, is shown in FIG. 12. It is envisaged that the graphical user interface will initially present a dashboard 1201, allowing a user of the local gateway 105 to perform common tasks for such a device, such as adding a new device, adding a user, viewing reports on existing users, configuring their network access policies, and setting up a guest user policy—the latter option defining a standard set of terms of network access when connected to the residential local area network provided by the local gateway 105 for unregistered devices.

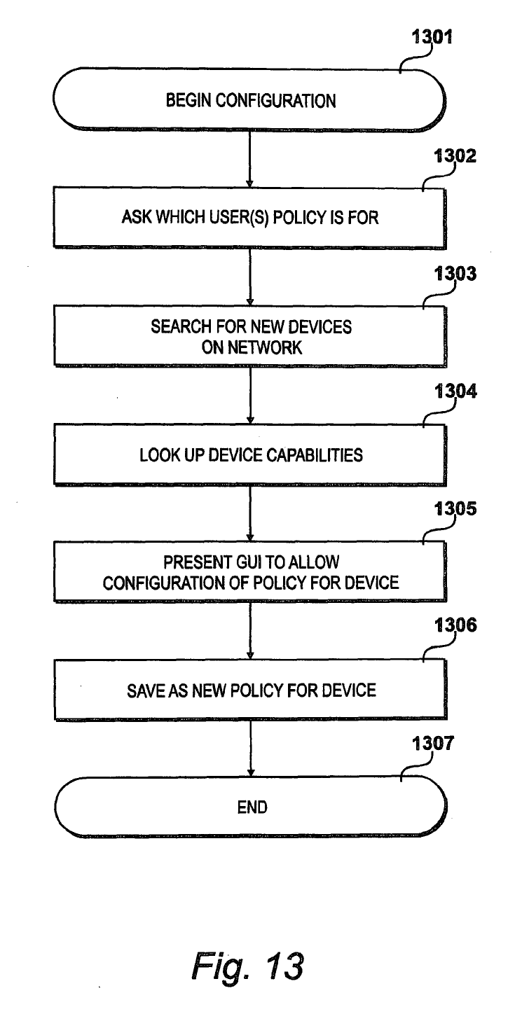

In this example, a user has, using a pointer 1202, clicked on a link 1203 to add a new device. FIGS. 13 to 18 set out the procedures and outcomes of doing so.

### FIG. 13

An overview of procedures invoked by when adding a new device and its registration with local gateway 105 is shown in FIG. 13.

Configuration begins at step 1301 with the selection of the link 1203 in the graphical user interface identified in FIG. 12. At step 1302, the user with which the new device should be associated is queried. At step 1303, a search is conducted in the present embodiment by using Universal Plug and Play (UPnP) procedures of the residential local area network for devices which are not yet registered on the local gateway 105. Any new devices are then queried for their capabilities at step 1304, returning, if UPnP is used, an XML device description document. At step 1305, a graphical user interface is presented to allow configuration of a network access policy for the device. This may be either application of an existing network access policy, possibly including the options to make changes, or creation of a bespoke network access policy for the device for example. Whichever the choice, an association between a network access policy and the device is then saved at step 1306, and configuration ends at step 1307.

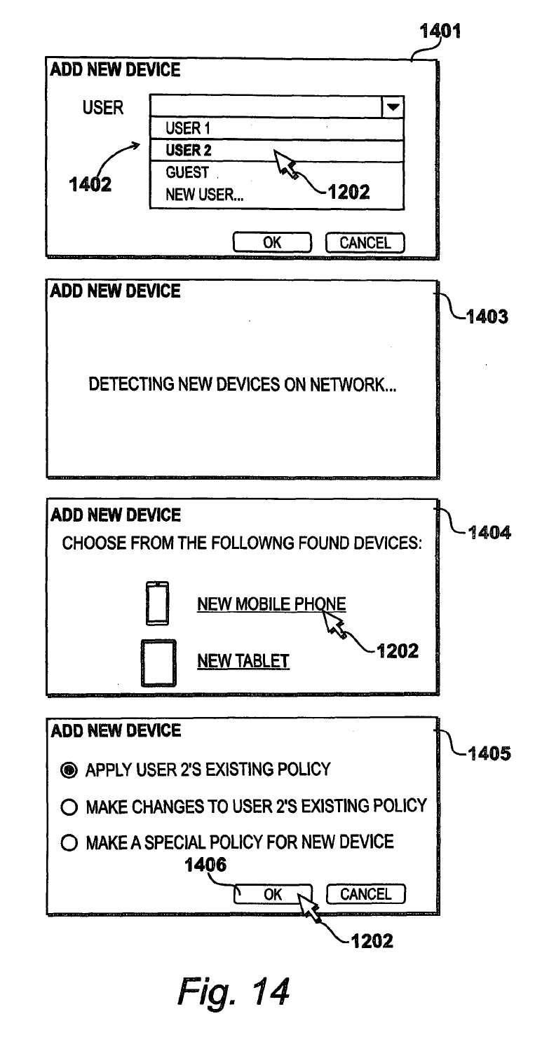

### FIG. 14

An exemplary set of graphical user interfaces presented to a user during configuration and registration of a new device with local gateway 105 is shown in FIG. 14.

A first GUI 1401 corresponding to step 1302 presents a drop down box 1402 from which a user for the new device may be selected. This drop down box 1402 may include, as in the present example, an option to add a new user or define the new device only as a guest. In the present example, USER 2 is selected using pointer 1202.

A second GUI 1403 is then presented whilst UPnP (Universal Plug and Play) discovery takes place at step 1303. Following this, a third GUI 1404 is presented when new devices have been identified and their attributes known following step 1304.

In this example, the new device to be added is a new mobile phone, selected by pointer 1202. A fourth GUI 1405 is then presented corresponding to step 1305, allowing selection of application of USER 2′s existing network access policy, the choice of making a change to USER 2′s existing network access policy, or the definition of a special network access policy solely for the new device. Clicking of an OK button 1406 by pointer 1202 then invokes step 1306, in this case associating USER 2′s existing network access policy with the new device.

### FIG. 5

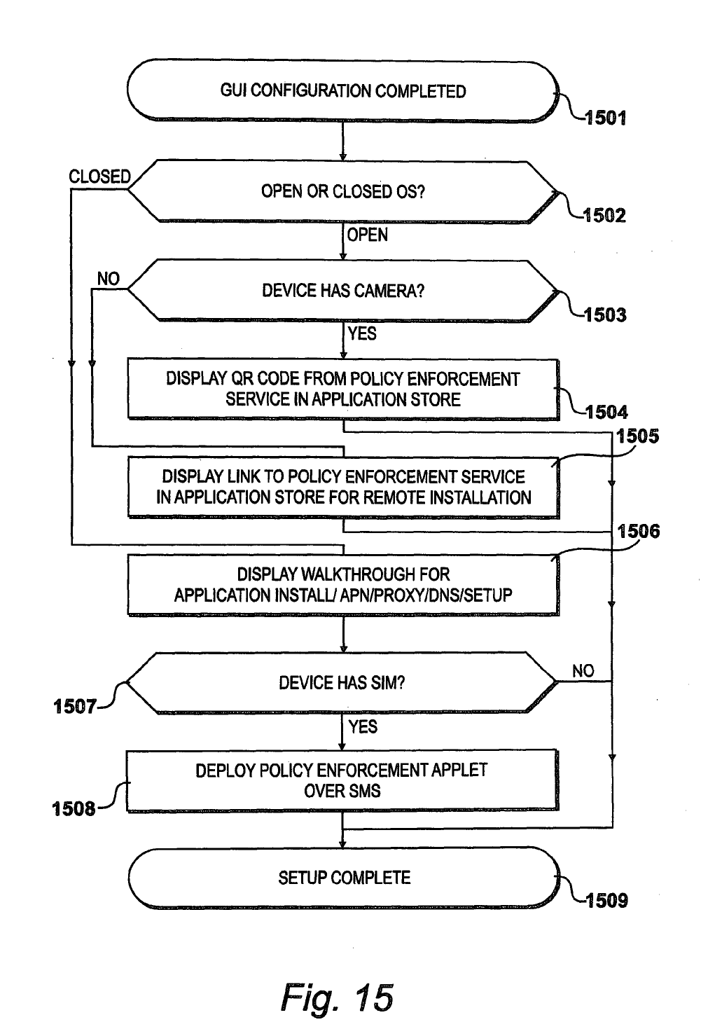

Procedures undertaken by local gateway 105 following step 1307 are shown in FIG. 15.

After GUI configuration has been completed (step 1501), a question is asked at step 1502 as to whether the added device has an open or a closed operating system. If the device has an open operating system, then at step 1503 a question is asked as to whether the device has a camera. If so, then at step 1504 a QR code is displayed embedding a link to an installer in the appropriate application store for the device for installation of the policy update service 1104 and the policy enforcement service 1105. If the device does not have a camera, then at step 1505 a clickable link is displayed to enable remote installation of the policy update service 1104 and the policy enforcement service 1105 using known application store services. Setup is then complete at step 1509.

If the question asked at step 1502 determined that the operating system was closed, then control proceeds to step 1506 where a walkthrough is displayed to enable the user to configure DNS, proxy server and APN settings as appropriate. A question is then asked at step 1507 as to whether the device has a USIM card installed. If this question is answered in the affirmative, then at step 1508 the policy update and enforcement applets 1008 and 1009 are sent to the device using SMS data download-type messages. Automatic installation then takes place on the USIM of the new device in accordance with the USIM application toolkit specification. Step 1508 is skipped if the question asked at step 1507 is answered in the negative. Again, setup is then complete at step 1509.

sFIG. 16

If the addition of a new device also involved an update to a creation of a new network access policy, or indeed a user's network access policy was changed directly from dashboard 1201 at one of the user terminals in the logical device family overseen by local gateway 105, then measures must be taken to deploy it to all appropriate devices. Procedures carried out by the distribution service 508 to update a network access policy are shown in FIG. 16.

At step 1601, a question is asked at to whether any of the network access policies 510 have been updated or if any new policies have been created through the GUI, and then stored in memory at the local gateway 105. If answered in the negative, then control proceeds directly to step 1606 where the distribution service 508 waits for a predetermined polling interval.

However, if the question asked at step 1601 is answered in the affirmative, then the updated network access policy is read at step 1602 and converted to a bitstream at step 1603. The conversion to a bitstream, as described previously with reference to FIG. 2, involves the conversion of the network access policy into a bit array. Public key encryption then takes place at step 1604, and distribution to the appropriate devices occurs at step 1605, which step will be described in further detail with reference to FIG. 17. After distribution is complete control proceeds to step 1606 where the distribution service 508 waits for a polling interval until returning to step 1601.

### FIG. 17

Steps carried out during step 1605 to distribute a policy to all applicable devices are shown in FIG. 17.

At step 1701, the device table 512 is read and the devices to which the particular network access policy should be distributed are ascertained. In the present embodiment, this involves identifying the network access policy currently installed on the device, details of which are stored in the devices table 512. The first matching device is selected at step 1702, and at step 1703 a question is asked as to whether the device has a USIM. If it does, then at step 1704 an SMS data download message is sent to the device containing the network access policy in its bitstream format. If the question asked at step 1703 was answered in the negative, then control proceeds to step 1705 in which the network access policy in its bitstream format is sent to the device using a peer to peer connection, possibly using a distributed hash table or similar technique to allow identification of the device despite network address translation etc.

Control proceeds to step 1706 from either step 1704 or step 1705 whereupon a question is asked as to whether any more devices require the network access policy to be sent to them. If answered in the affirmative then control returns to step 1702 where the next device is selected from the devices table 512. Otherwise, control proceeds to step 1707 where the network access policy is sent to the enforcement server using a peer to peer connection. Step 1605 is then complete.

### FIG. 18

Following completion of the addition of devices, users, policies and the distribution thereof, relationships can be mapped out between the entities. Such a relationship diagram is shown in FIG. 18.

The logs 511 are related to each user, defined in the users table 513. This relationship is many-to-one, in that each user may have many logs, and those logs are specific to one user. The users table 513 is related to the device table 512 in a many-to-one relationship, in that one user may have many devices. Network access policies 510 may individually be related to many users, as a plurality of users may share the same network access policy. In addition, many devices may share the same device-specific network access policy.

### Policy Enforcement

### FIG. 19

A high level overview of procedures undertaken to enforce a network access policy against TCP/IP data is set out in FIG. 19. The illustrated steps are suitable for execution by all of policy enforcement service 506 on local gateway 105, policy enforcement service 706 on policy enforcement server 110, or policy enforcement service 1105 on smartphone 103.

At step 1901, packet inspection takes place. In the present embodiment, stream processing is employed to improve data throughput rates. At step 1902, a question is asked as to whether an HTTPS session is being initiated by a browser. If so, the present invention provides a mechanism by which such sessions can be supplemented with information pertaining to the veracity and trustworthiness of the service provide. Thus at step 1903, the destination website is screened. In the present embodiment screening includes a process of cross referencing the local company register (by scraping the privacy policy etc. for a company name) and domain registrar data along with analysing the competency of the spelling and grammar on the site. Following this analysis, a question is asked as to whether the destination website is suspected of being fraudulent. If so, then the HTTPS session is tagged such that the webpages include a warning message for the user, alerting them to the low trustworthiness of the website. This could be achieved by injection of additional HTML into the webpages delivered to the browser.

If no HTTPS session is initiated, or the website is not deemed to be suspect, the control proceeds to step 1906 where the network access policy is applied. Procedures carried out in step 1906 are described further with reference to FIGS. 20 to 26.

### FIG. 20

In order to determine whether a content being received via the Internet complies with the network access policy, it is intercepted to allow a degree of processing to be performed on the packet to extract its content and put it in context with other packets takes place at step 2001. Step 2001 will be described in further detail with reference to FIG. 21.

At step 2002, following processing of the packet a question is asked as to whether it meets the content restrictions. Steps carried out to determine the response to this question are set out in FIG. 22. If so, then a question is asked at step 2003 as to whether it meets the time of day restrictions. If so, the a question is asked as to whether the source or destination of the data meets the restrictions defined in the network access policy, such as blacklisted websites. If so, then a question is asked as to whether any other of the terms of the network access policy are met. If so, then the packet complies with the network access policy and is allowed at step 2006. If any one of the questions asked at steps 2002 to 2005 is answered in the negative, then the packet does not meet the terms of the network access policy and the packet is disallowed at step 2007.

### FIG. 21

Steps carried out to process packet contents so as to perform content based filtering are set out in FIG. 21.

At step 2101, a question is asked as to whether the packet is destined for or originates from an approved application, set out in the network access policy. If so, then a question is asked as to whether the content includes any text. If so, then language processing is performed at step 2103 in line with the degree of linguistic filtering set out in the network access policy, along with application of keyword filtering.

A question is then asked at step 2104 as to whether any image content is present. If so, then image filtering is applied at 2105 to identify any prohibited content. At step 2106, arrived at also if either question asked at steps 2102 or 2104 was answered in the negative, then a heuristic matching procedure is applied to identify any other content contravenes the policy, despite not being identified as text or image. Following these three steps of analysis, a question is asked at step 2107 as to whether there has been a contravention of the policy. If not, then step 2001 is complete. If there has been a contravention, then a contravention flag is set at 2108.

### FIG. 22

Following content analysis during step 2001, it must be determined whether to approve or deny the content. The present invention takes a pragmatic approach, appreciating that a complete block on offending messages for example is not always the fairest approach. To this end, an embodiment of the present invention employs a “three strikes” approach by offering, for example a user to confirm whether they really want to send a message, or if they really want to view certain content.

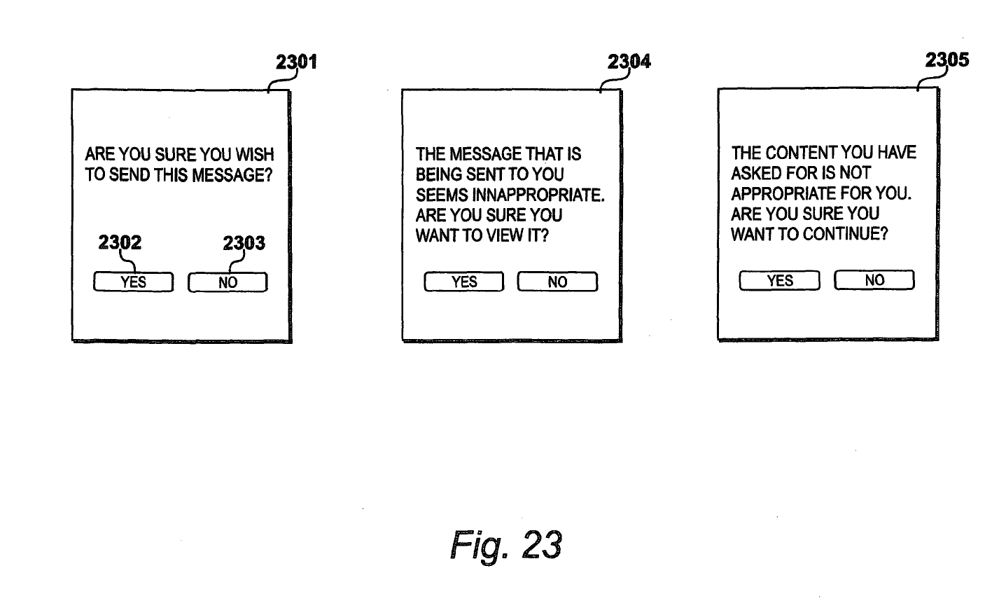

Thus step 2002 involves firstly asking at step 2201 a question as to whether a contravention was identified at step 2001, by determining whether the contravention flag was set during step 2208. If so, then a contravention counter is incremented at step 2202. A question is asked at step 2203 as to whether a contravention threshold has now been exceeded. In the present example, the threshold is three. If not, then at step 2204 a warning is given. In the present example this is an alert displayed to the user, dependent on the nature of the contravention. Example alerts are identified in FIG. 23.

Following issuance of a warning, a response is waited on at step 2205, and at step 2206 a question is asked as to the nature of the input given in response to the warning. If the response is to proceed, then at step 2207 the content is logged with the local gateway 105 and the content is approved at step 2208. Step 2208 is also invoked if the question asked at step 2201 was answered in the negative, to the effect that no contravention was identified. If the response given to the warning at step 2204 was to not proceed, then the request is dropped at step 2209. Following step 2208 or 2209, step 2002 is complete.

If the question asked at step 2203 was answered in the affirmative, to the effect that the contravention threshold was exceed, then an alert is immediately sent to a guardian at step 2210, possibly via email or SMS message, and the content is denied at step 2211. Step 2002 is then complete.

### FIG. 23

Example warning dialog boxes which can be displayed on a user terminal, either by browser pop up, USIM application toolkit dialogs or operating system alerts, are shown in FIG. 23.

Thus following interception of the dispatch of a message from a text-based application, such as an SMS application or a real-time chat application, a first warning dialog box 2301 can be deployed if a user attempts to send a message containing unsavoury language for example. The linguistic filtering will capture the language and identify it as being prohibited in accordance with the network access policy. A moment's pause can be had to reflect on the message and whether it really should be sent. In response to selection of the “YES” button 2301, the message will be sent but also logged at local gateway 105 for review. In this way, a log is made and stored in memory at the local gateway 105 when a prohibited action is attempted at a user terminal. In response to selection of the “NO” button 2302, the user will return to composing the message and thus has the opportunity to edit its content.

A second warning dialog box 2304 can be deployed when an incoming message, either text (e.g. SMS) or picture based (e.g. MMS) for example, is determined to be inappropriate in accordance with the network access policy it is screened against. A third warning dialog box 2305 can be deployed for example when a web resource is determined, possibly by the heuristic matching procedure, to be inappropriate, possibly with reference to the user's sex and age.

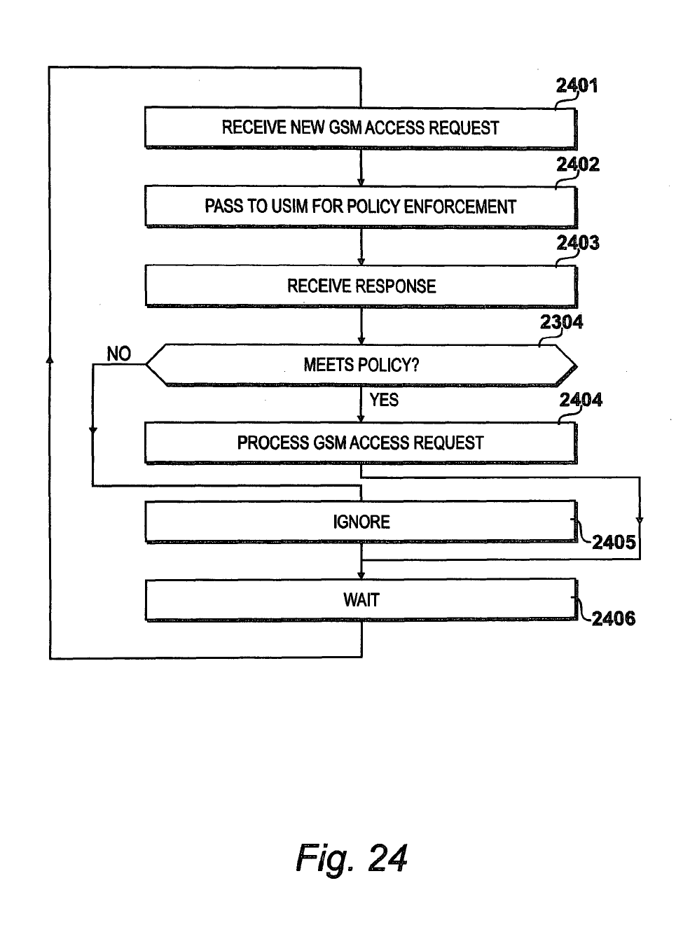

### FIG. 24

Procedures carried out by the baseband service 1003 when a GSM access request is received (e.g. call or SMS) are set out in FIG. 24.

At step 2401, an access request is received, possibly from the phone or SMS applications 1005, or because an incoming call or SMS is being received. In accordance with the standard GSM specification, this request is passed to the USIM 806 at step 2402, where policy enforcement may be carried out by the policy enforcement applet 1009. In this way, the access request is intercepted. A response is then received from the USIM 806 at step 2403, and a question is asked at step 2404 as to whether the access request met the policy. If it did, then the request is processed at step 2405, and if it did not then it is ignored at step 2406. The baseband service 1003 then waits at step 2407 for the next GSM access request.

### FIG. 25

As described previously, the policy enforcement applet 1009 is registered with the USIM application toolkit of the USIM 806 to be called into action when certain GSM events are identified, such as Call Control and SMS Control

Thus when the GSM access request is passed to the USIM 806 by the baseband service 1003, the requests are in turn passed to the policy enforcement applet 1009 whereupon a decision can be made as to their compliance with the network access policy 109. Procedures carried out to assess a GSM access request's compliance are detailed in FIG. 25

At step 2501, the GSM access request is received (intercepted) by policy enforcement applet 1009, and at step 2502 a question is asked as to the nature of the request. If it is an SMS message, then the message contents are processed at step 2503 which will be described further with reference to FIG. 26. Following processing, a question is asked at step 2504 as to whether the message meets the content restrictions of network access policy 109.

If so, or if the access request is a call, then a question is asked at step 2505 as to whether it meets the time of day restrictions. If so, then a question is asked at step 2506 as to whether the source or destination of the request meets the restrictions defined in the network access policy 109, such as blocked numbers. If so, then a question is asked at step 2507 as to whether any other of the terms of the network access policy are met. If so, then the access request complies with the network access policy 109 and is allowed at step 2508.

If any one of the questions asked at steps 2504 to 2507 is answered in the negative, then the request does not meet the terms of the network access policy 109 and the request is disallowed at step 2509. The appropriate response is therefore sent to the baseband service 1003 at step 2510.

### FIG. 26

As described previously, the content of an SMS message is processed to determine if it contravenes the network access policy 109. Step 2503 is set out in detail in FIG. 26.

At step 2601, a question is asked as to whether a data connection is available. If so, then at step 2602 the SMS message contents are transmitted using bearer independent protocol via the baseband processor 805 to the policy enforcement server 110, where its natural language processing and sentiment analysis services can be utilised. A question is then asked at step 2603 as to whether the message is approved or denied. If approved, then the message is set as meeting the content restrictions at step 2606, and then the question asked at step 2504 may be answered in the affirmative. If not, then then the message is set as not meeting the content restrictions at step 2607, and so the question asked at step 2504 may be answered in the negative.

If no data connection is available, then the local dictionary 1010 is used to enable a regular expression search of the message for keywords that are not allowed by the policy at step 2604. A question is then asked at step 2605 as to whether a match has been found. If not, then again the message is set as meeting the content restrictions at step 2606, and the question asked at step 2504 may be answered in the affirmative. If not, then then the message is set as not meeting the content restrictions at step 2607, and the question asked at step 2504 may be answered in the negative.

1. A system in which a network access policy is distributed from a gateway device to each one of a plurality of user terminals forming a logical device family for enforcement, wherein:
the gateway device is configured as a router between the Internet and a private local area network;
each one of the plurality of user terminals is capable of connecting to either the private local area network or a cellular data network to access the Internet;
the gateway device is configured to distribute the network access policy to each one of the plurality of user terminals, said network access policy having user-defined parameters specifying terms of access to the Internet;
the plurality of user terminals are configured to abide by the network access policy whether they are connected to said private local area network or to said cellular data network.

2. The system of claim 1, in which the user-defined parameters specify allowed periods of access to the Internet.

3. The system of claim 1, in which the user-defined parameters specify acceptable usage of the Internet.

4. The system of claim 3, in which the user-defined parameters prohibit access to particular websites.

5. The system of claim 3, in which the user-defined parameters prohibit use of particular applications.

6. The system of claim 3, in which the user-defined parameters prohibit sending or receipt of messages containing prohibited content.

7. The system of claim 4, in which a log is made and stored in memory at the gateway device when a prohibited action is attempted at a user terminal.

8. The system of claim 1, in which the user terminals are one or more of:
a cellular telephone;
a tablet computer;
a personal computer.

9. The system of claim 1, in which compliance with the network access policy is determined by an application running on a subscriber identity module in each of the user terminals.

10. The system of claim 1, in which the gateway device is configured to:
receive an instruction via a graphical user interface at one of the plurality of user terminals in the logical device family to create a new network access policy;
create and store the new network access policy in non-volatile memory in the gateway device;
convert the new network access policy into a bitstream for distribution to each one of the user terminals;
distributing the new network access policy as said bitstream to each one of the user terminals.

11. A method in which a network access policy is distributed from a gateway device to each one of a plurality of user terminals forming a logical device family for enforcement, in which:
the gateway device is configured as a router between the Internet and a private local area network, and each one of the plurality of user terminals is capable of connecting to either the private local area network or a cellular data network to access the Internet;
and the method comprises:
distributing, by the gateway, the network access policy to each one of the plurality of user terminals, said network access policy having user-defined parameters specifying terms of access to the Internet; and
each one of the plurality of user terminals abiding by the network access policy whether they are connected to said private local area network or to said cellular data network.

12. The method of claim 11, in which the user-defined parameters specify allowed periods of access to the Internet.

13. The method of claim 11, in which the user-defined parameters specify acceptable usage of the Internet.

14. The method of claim 13, in which the user-defined parameters prohibit access to particular websites.

15. The method of claim 13, in which the user-defined parameters prohibit use of particular applications.

16. The method of claim 13, in which the user-defined parameters prohibit sending or receipt of messages containing prohibited content.

17. The method of claim 14, in which a log is made and stored in memory at the gateway device when a prohibited action is attempted at a user terminal.

18. The method of claim 11, in which the user terminals are one or more of:
a cellular telephone;
a tablet computer;
a personal computer.

19. The method of claim 11 in which compliance with the network access policy is determined by an application running on a subscriber identity module in each of the user terminals.

20. The method of claim 11, in which the gateway performs the steps of:
receiving an instruction via a graphical user interface at one of the plurality of user terminals in the logical device family to create a new network access policy for distribution to at least one of the user terminals;
creating and storing the new network access policy in non-volatile memory in the gateway device;
converting the new network access policy into a bitstream at the gateway device for distribution to each one of the user terminals.
